(19) United States
(12) Patent Application Publication
(10) Pub. No.: US 2007/0171149 A1
(43) Pub. Date: Jul. 26, 2007

(54) Plasma display panel apparatus and method of driving the same

(76) Inventors: Shinichiro Hashimoto, Toyonaka-shi (JP); Masatoshi Kitagawa, Hirakata-shi (JP); Yukihiro Morita, Hirakata-shi (JP); Naoki Kosugi, Kyoto-shi (JP)

Correspondence Address: SNELL & WILMER L.L.P. (Matsushita), 600 ANTON BOULEVARD, SUITE 1400, COSTA MESA, CA, 92626, US

(21) Appl. No.: 10/559,043

(22) PCT Filed: Jun. 23, 2004
(86) PCT No.: PCT/JP04/09206

§ 371 Date: Dec. 14, 2006

(30) Foreign Application Priority Data
Jun. 23, 2003 (JP) 2003-178157

(51) Int. Cl. G09G 3/28

(52) U.S. Cl. 345/60

(57) ABSTRACT

The present invention aims to provide a PDP apparatus, where a sustain data pulse is applied to data electrodes during a sustain period, having high display quality,and capable of displaying a dark screen image vividly with high contrast without using an error diffusion method, as well as to provide a method of driving the PDP apparatus. In order to achieve the above object, the method of driving the PDP apparatus according to the present invention, during the sustain period, detects an average luminance of a screen image to be displayed, and sets a voltage waveform of a sustain data pulse to be applied to the data electrodes according to the detected average luminance, thereby modulating a luminance of the screen image.

### TECHNICAL FIELD

The present invention relates to a plasma display panel apparatus and a method of driving the same, and more specifically, it relates to a technique of driving the apparatus that improves qualities of a screen image.

### BACKGROUND ART

Plasma display panel (PDP) apparatuses have relative ease in increasing a screen size, in comparison with cathode ray tube (CRT) display apparatuses that are currently most commonly used. Such PDP apparatuses attract attentions as image display apparatuses suitable for hi-vision broadcasting. The PDP apparatuses are typically classified into an alternating current (AC) type and a direct current (DC) type. At present, AC-type PDP apparatuses (hereinafter referred to simply as PDP apparatuses) form a mainstream because of their superiority in a variety of aspects such as reliability and display quality.

Generally, with the PDP apparatuses, an image for one screen (a screen image) becomes unclear with low luminance, i.e. the screen image has a low contrast ratio, when displaying a screen image that is overall dark and has little bright area (hereinafter referred to as a “dark image screen”). This incurs deterioration of the display quality, and therefore, various attempts from an aspect of driving methods have been made in order to improve such a problem.

A commonly employed method of driving the PDP apparatuses is a field time-sharing grayscale display method. According to this method, one field (correspond to one screen image) is divided into sub-fields each including an address period and a sustain period. Images for the sub-fields are then chronologically integrated so as to display the field in grayscale.

A known method of improving the display quality using the field time-sharing grayscale display method is to enhance a peak luminance by increasing a number of sustain discharges generated during the sustain period when displaying a dark image screen (See Unexamined Japanese Patent Publication Number 2002-536689).

In general, power consumption decreases when a dark screen image is displayed, because an area of the screen image that emits flight becomes small. This allows a driving circuit for the sustain discharge to have reserve capacity. According to the above cited patent publication, the peak luminance is enhanced by increasing the number of the sustain discharges so as not to exceed the capacity of the driving circuit, allowing the apparatus to display the dark screen image clearly and vividly (with high contrast).

According to the above cited conventional art, however, the number of the sustain discharges always has to be integrally multiplied in order to display the dark screen image in a correct grayscale by increasing the number of the sustain discharges. Therefore, it is necessary to virtually display the grayscale using an error diffusion method when the number of the sustain discharges has to be increased by other than integral multiplication. Naturally, a relatively expensive circuit capable of performing error diffusion is required for the PDP apparatuses, and a problem has been noted that such a circuit is more complex in structure, and results in an increase of the production cost.

### DISCLOSURE OF THE INVENTION

In view of the above problem, an object of the present invention is to provide a PDP apparatus having a high display quality and a method of driving such a PDP apparatus, capable of displaying a dark screen image clearly and vividly without requiring a complex driving circuit.

The above object is achieved by a plasma display panel apparatus comprising a panel device being a sealed container that includes two parts facing each other across a discharge space in which a discharge gas is enclosed, one of the parts having a plurality of electrode pairs of a first electrode and a second electrode, the other of the parts having a-plurality of third electrodes, and discharge cells being formed where the third electrodes cross over the electrode pairs; and a drive device driving the panel device to perform image display, based on inputted image data, by sequentially generating an address discharge between the first and third electrodes and a sustain discharge between the first and second electrodes in selected discharge cells, wherein the drive device includes: a detecting unit operable to detect, from the inputted image data, an average luminance of a screen image to be displayed; and a control unit operable to, when generating the sustain discharge, apply a modulation voltage that is set according to the average luminance to the third electrodes, thereby modulating a luminance of the screen image when displayed.

The above object is also achieved by a method of driving a plasma display panel apparatus in which a panel device is driven to perform image display, based on inputted image data, by sequentially generating an address discharge and a sustain discharge, the panel device being a sealed container including two parts; facing each other across a discharge space in which a discharge gas is enclosed, discharge cells being formed where a plurality of third electrodes disposed on one part cross over a plurality of electrode pairs disposed on the other part, each of the electrode pairs including a first electrode and a second electrode, the address discharge being performed between the first and third electrodes in selected discharge cells, and the sustain discharge being performed between the first and second electrodes in the selected discharge cells, the method comprising steps of: detecting, from the inputted image data, an average luminance of a screen image to be displayed; and controlling to, when generating the sustain discharge, apply a modulation voltage that is set according to the average luminance to the third electrodes, thereby modulating a luminance of the screen image when displayed.

The inventors of the present invention found that the voltage waveform applied to the third electrodes according to the average luminance can be set without using an error diffusion method, and thus it is possible to modulate the luminance of the screen image continuously, and to control a peak luminance for each screen image with maintaining a correct grayscale when generating a sustain discharge between the first and second electrodes (hereinafter referred to as sustain period) . Therefore, with the PDP apparatus and the method of driving the same according to the present invention, it is possible to improve the peak luminance when displaying a dark screen image by modulating the luminance for each screen image without being restricted to integral multiplication of the grayscale like in the conventional method of increasing the number of the sustain discharges. Thus, with the PDP apparatus and the method of driving the same according to the present invention, even the dark screen image can be displayed vividly with high contrast with maintaining a correct grayscale and without using an error diffusion method.

In order to sequentially modulate the luminance in this way, the modulation voltage may, have a pulse waveform, and the control unit may set a fall start time of the pulse waveform according to the average luminance. Here, the fall start time in the voltage waveform indicates a time when the voltage starts to fall.

In an example of specific methods of luminance modulation, a rise start time of the pulse waveform is set in sync with a rise start time of a voltage waveform applied between the first and second electrodes, and the fall start time is set based on a pulse width (a time period between the rise start time and the fall start time) set according to the average luminance. By employing such a method, it is possible for the PDP apparatus according to the present invention to display screen images with high contrast.

In another example of the specific methods of modulation, the pulse waveform has a predetermined pulse width, and in the controlling, the fall start time is set based on a rise start time set according to the average luminance.

In yet another example of the specific methods of modulation, the modulation voltage has a pulse waveform, and the control unit sets an amplitude of the pulse waveform according to the average luminance. In the above examples, it is more preferable to apply the voltage having a pulse waveform, in terms of control effectiveness.

It is more preferable that the control unit sets a cycle of the pulse waveform according to the average luminance because a number of sustain discharge can be increased. In this case, it is desirable that the control unit sets a cycle of a voltage waveform applied between the first and second electrodes when generating the sustain discharge, according to the average luminance.

When the panel device of the plasma display panel apparatus according to the present invention includes a front panel having scan electrodes and sustain electrodes and a back panel having data electrodes, the third electrodes correspond to the data electrodes and the drive device applies the modulation voltage to the data electrodes according to the average luminance during the sustain period.

Further, in a case in which auxiliary electrodes are provided to the back panel in addition to the data electrodes, it is also possible to apply the modulation voltage to either both or one of the data and auxiliary electrodes during the sustain period. When taking a margin of the voltage application during the sustain period into account, it is desirable to apply the modulation voltage alternately to the data and auxiliary electrodes. By this, a cycle of the modulation voltage applied to one of the electrodes can be increased twice as much, in comparison with the case in which the modulation voltage is applied to only one of the data and auxiliary electrodes. Thus, it is possible to improve the effectiveness of the present invention.

As described above, the plasma display panel apparatus and the method of driving the same according to the present invention include the control unit that, during the sustain period, sets the waveform of the modulation voltage to be applied to the third electrodes that are provided to the panel device, according to the average luminance of the image screen to be displayed. Therefore, it is possible to modulate the luminance with maintaining the correct grayscale of a dark screen image without using the error diffusion method, thereby displaying the dark screen image vividly with high contrast and high image qualities. Further, in the plasma display panel apparatus and the method of driving the same according to the present invention, the modulation voltage is set according to the average luminance of the screen image to be displayed, and, when displaying the dark screen image, this improves the peak luminance of the screen image to be displayed by modulating the luminance with maintaining the correct grayscale without using the error diffusion method. As a result, it is possible to display the screen image more vividly with high contrast.

### BRIEF DESCRIPTION OF THE DRAWINGS

FIG. 1 is a block diagram illustrating a structure of a PDP apparatus according to a first embodiment.

FIG. 2 is a perspective (partially sectional) view illustrating a panel device 100 according to the first embodiment.

FIG. 3 is a plain view illustrating the panel device 100.

FIG. 4 illustrates waveform patterns showing pulses applied to each of the electrodes when driving the PDP apparatus according to the first embodiment.

FIG. 5 illustrates waveform patterns applied to each of the electrodes during a sustain period 311 when driving the PDP apparatus according to the first embodiment.

FIG. 6 is a chart indicating relation between a best fall start time of the sustain data pulse and a standardized luminance level.

FIG. 7 illustrates an example in which the standardized luminance level shown in FIG. 6 is applied according to an average picture level (APL).

FIG. 8 is a schematic diagram illustrating discharge paths of a sustain discharge generated in a discharge space.

FIG. 9 is a flowchart showing operations, performed by a best sustain data pulse process unit 241 in the PDP apparatus according to the first embodiment.

FIG. 10 illustrates waveform patterns indicating times when voltage pulses are applied to respective electrodes during a sustain period 311.

FIG. 11 illustrates waveform patterns of pulses applied to the respective electrodes during the sustain period 311 the PDP apparatus according to a second embodiment.

FIG. 12 is a flowchart showing operations performed by the best sustain data pulse process unit 241 in the PDP apparatus according to the second embodiment.

FIG. 13. illustrates waveform patterns indicating times when the pulses are applied to the respective electrodes during the sustain period 311 in the PDP apparatus according to the second embodiment.

FIG. 14 illustrates waveform patterns indicating the pulses applied to the respective electrodes during the sustain period 311 in the PDP apparatus according to a third embodiment.

FIG. 15 illustrates waveform patterns indicating the pulses applied to the respective electrodes during the sustain period 311 in the PDP apparatus according to the third embodiment.

FIG. 16 is a perspective (partially sectional) view illustrating a panel device 101 in the PDP apparatus according to a fifth embodiment.

FIG. 17 illustrates waveform patterns showing pulses applied to each of the electrodes when driving the PDP apparatus according to the fifth embodiment.

FIG. 18 is a perspective (partially sectional) view illustrating a panel device 102 according to a sixth embodiment.

FIG. 19 is a sectional view illustrating a positional relation of each of the electrodes.

FIG. 20 illustrates a modified example of waveform patterns showing pulses applied to each of the electrodes when driving the PDP apparatus.

### BEST MODE FOR CARRYING OUT THE INVENTION

The following describes preferred embodiments of a PDP apparatus and a method of driving the same according to the present invention with reference to the drawings.

### FIRST EMBODIMENT

1. Structure of PDP Apparatus

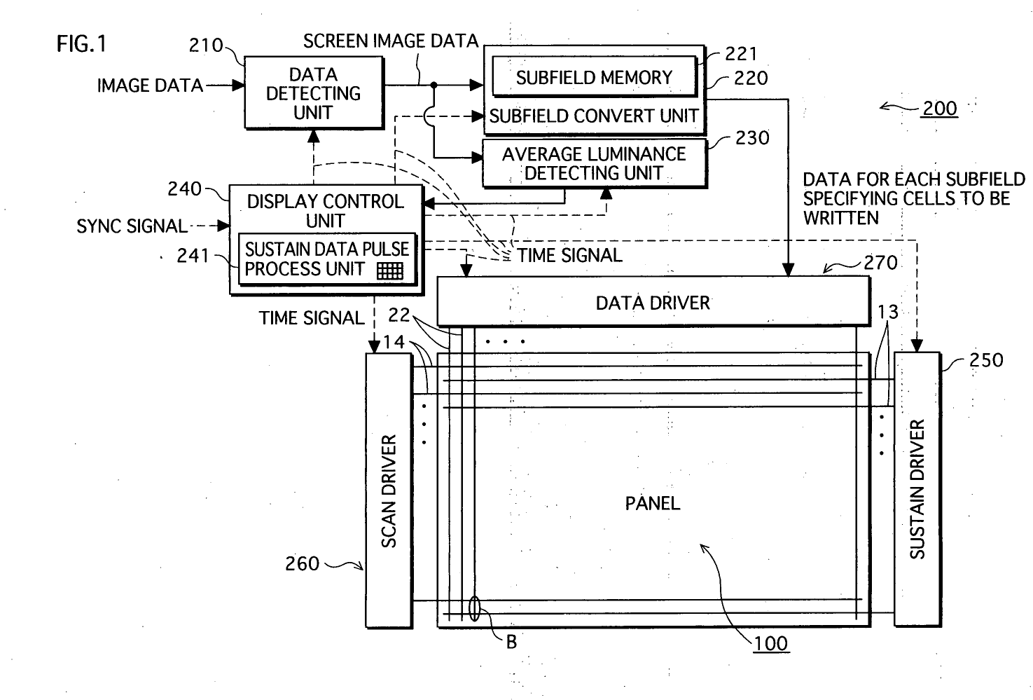

An overall structure of the PDP apparatus is described with reference to FIG. 1. FIG. 1 is a block diagram illustrating the structure of the PDP apparatus according to a first embodiment.

As shown in FIG. 1, the PDP apparatus according to the present embodiment includes a panel device 100 for displaying images and a drive device 200 for driving the panel to display the images using a field time-sharing grayscale display method.

1-1. Structure of Panel Device 100

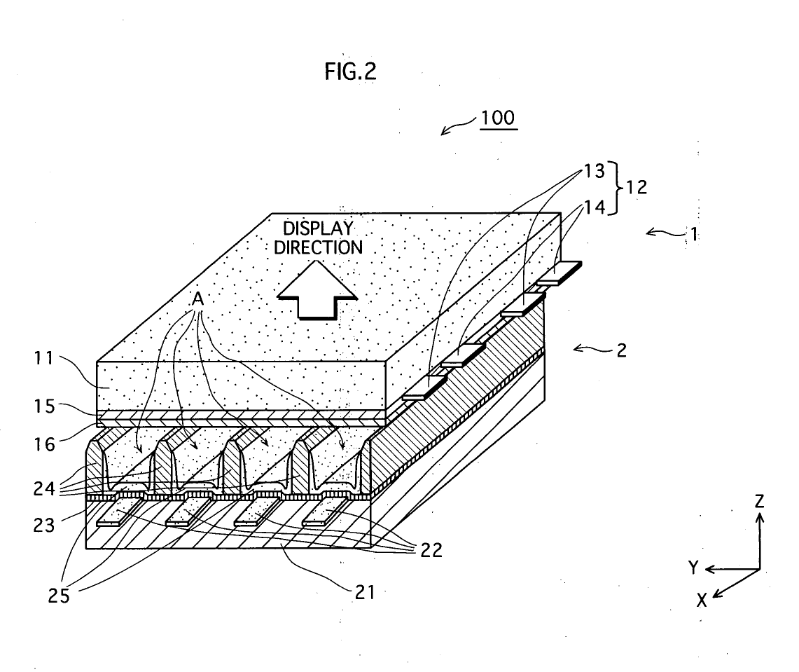

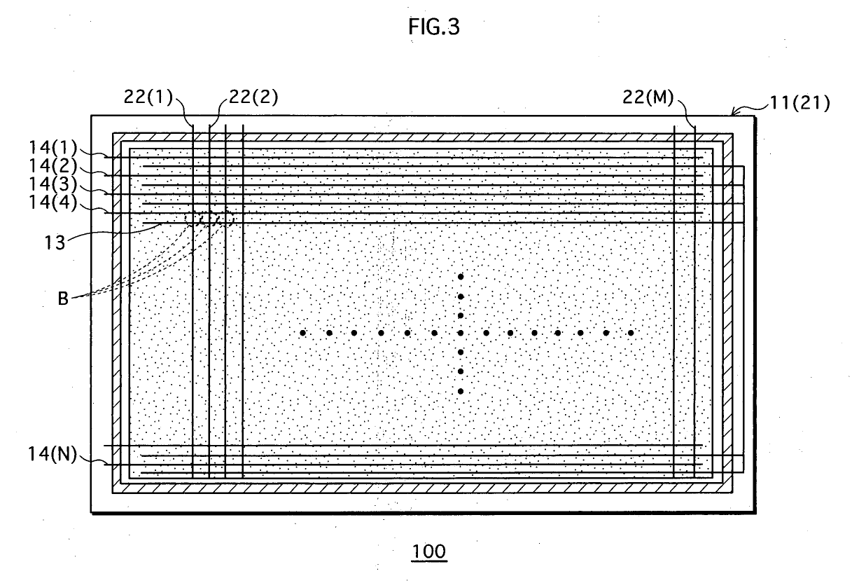

The following describes a structure of the panel device 100 in the PDP apparatus according to the present embodiment, with reference to the FIGS. 2 and 3. FIG. 2 is a perspective (partially sectional) view illustrating a main part of the panel device 100, and FIG. 3 is a plain view illustrating the panel device 100.

As shown in FIG. 2, the pane device 100 includes a sealed container structured by a front panel 1 and a back panel 2 facing each other with a space therebetween.

The front panel 1 has the following structure. On a surface of a front substrate 11 facing the back panel 2 (lower surface in FIG. 2), a plurality of display electrode pairs 12 are disposed in parallel. Each display electrode pair 12 includes a sustain electrode (hereinafter referred to as a Scn electrode) 13 and a scan electrode (hereinafter referred to as a Scn electrode) 14. A dielectric layer 15 and a protection layer 16 are formed over the surface of the front substrate 11 in a stated order so as to cover the display electrode pairs 12.

Each of the Sus electrodes 13 and Scn electrodes 14 is disposed along a Y direction in FIG. 2, and is a combination of a transparent electrode made of such as ITO (tin doped indium oxide), tin oxide (SnO₂), and zinc oxide (ZnO) and a bus line made of such as Cr—Cu—Cr and Silver (Ag) to lower an electric resistance.

Further, the dielectric layer 15 is made of a low-melting glass material, and the protection layer 16 is mainly made of MgO.

On the other hand, the back panel 2 has-the following structure. On a surface of a back substrate 21 facing the front panel 1 (upper surface in FIG. 2), a plurality of data electrodes (hereinafter referred to as Dat electrodes) 22 are disposed so as to cross over the display electrode pairs 12. A dielectric layer 23 is formed over the surface of the back substrate 21 so as to cover the Dat electrodes 22. In addition, a peak-like barrier rib 24 is disposed between two pairs of adjacent Dat electrodes 22 on a surface of the dielectric layer 23. Phosphor layers 25 are disposed, in a direction along the Dat electrodes 22, on inner walls of respective grooves each of which is surrounded by the dielectric layer 23 and two adjacent barrier ribs 24. Each of the phosphor layers 25 in the respective grooves is one of red (R), green (G) and blue (B).

Each of the Dat electrodes 22 is disposed in stripes along an X direction in FIG. 2, which is a direction to cross over the display electrode pairs 12, and is mainly made of such as Ag. As a material for the Dat electrodes 22, a metal material such as gold (Au), chromium (Cr), copper (Cu), nickel (Ni), and platinum (Pt), or a combination of these metals in lamination.

The dielectric layer 23 basically has the same structure as the dielectric layer 15 of the front panel 1, and made of the low melting glass material. However, the dielectric layer 23 may contain such as titanium oxide (TiO₂). The barrier ribs 24 are made of such as a lead glass material.

The phosphor layers 25 have colors of the corresponding grooves as described above, and phosphor materials listed below may be used for the respective colors.

Red (R) Phosphor: (Y, Gd) BO₃:Eu

Green (G) Phosphor: Zn₂SiO₄:Mn

Blue (B) Phosphor: BaMg₂Al₁₄O₂₄:Eu

The panel device 100 of the PDP apparatus is structured by the front panel 1 and the back panel 2 sealed with glass frit around periphery of the panels, in a manner that the both panels are positioned so as to face each other with the barrier ribs 24 as a gap material therebetween, and so that the display electrode pairs 12 and Dat electrodes 22 are disposed on the respective substrates to be substantially orthogonal to each other. By this, the space between the front panel, 1 and back panel 2 is partitioned by the barrier ribs 24 to form discharge spaces A in which a discharge gas made of such as neon (Ne), xenon (Xe), and helium (He) are filled. A filling pressure of the discharge gas is roughly in a range of 50 kPa to 80 kPa, for example. A partial pressure of Xe in the discharge gas may be 5% and above or 10% and above.

As shown in FIG. 3, in the panel device 100, the Sus electrodes, 13 and Scn electrodes 14 are disposed so as to lie substantially orthogonal to the Dat electrodes 22. Parts where the display electrode pairs 12 cross over the Dat electrodes 22 are discharge cells B.

1-2. Structure of Drive Device 200

The following describes a-structure of the drive device 200 of the PDP apparatus according to the present embodiment.

As illustrated in FIG. 1, the drive device 200 includes a data detecting unit 210, a subfield convert unit 220, an average luminance detecting unit 230, the display control unit 240, the sustain driver 250, the scan driver 260, and the data driver 270.

The data detecting unit 210 detects screen image data for each screen (grayscale value of each cell) from image data indicating grayscale value of each cell of the panel device 100 inputted from outside, and then transfer the detected data to the subfield convert unit 220 and average luminance detecting unit 230 sequentially. A vertical sync signal in the image data may be used as a reference in the detection of the screen image data for each screen. Further, when each cell is in a 256 grayscale, the grayscale value per cell is expressed in 8 bit in the screen image data.

The subfield convert-unit 220 is provided with a subfield memory 221, and converts the screen image data transferred from the data detecting unit 210 into subfield data that is a collection of binary data indicating whether each discharge cell in a subfield is to be turned on or off, for displaying an image in grayscale in the panel device 100 of the PDP apparatus. The subfield convert unit 220 then stores the subfield data in the subfield memory 221. After that, controlled by the display control unit 240, the subfield data is transmitted to the data driver 270.

The average luminance detecting unit 230 calculates an average grayscale value, based on the screen image data that is transferred from the data detecting unit 210 and indicates the grayscale values of the discharge cells for one screen, by multiplying all grayscale values for the screen and then dividing the multiplied grayscale values by a number of the discharge cells. The average luminance detecting unit 230 further calculates an average luminance indicating a percentage of the derived average grayscale value in a maximum grayscale (256 grayscale, for example), and transmits to the display control unit 240. When the average luminance is low, the screen image is a dark screen image, and when the average luminance is high, the screen image is a bright screen image.

The display control unit 240 is inputted with synchronizing signals in sync with the image data (a horizontal synchronizing signal (Hsync) and a vertical synchronizing signal (Vsync), for example).

The display control unit 240, based on the synchronizing signals, transmits a time signal instructing the data detecting unit 210 a time of transferring the screen image data, a time signal instructing the subfield convert unit 220 a time of writing to and reading from the subfield memory 221, the time signal instructing the average luminance detecting unit 230 a time of calculating the average luminance, and a time signal instructing the sustain driver 250 times of applying pulses to the scan driver 260 and data driver 270, respectively. These time signals also include a time signal instructing the data driver 270 a time of applying a sustain data pulse during a sustain period. Accordingly, the display control unit 240 includes a sustain data pulse process unit 241 that determines an appropriate fall start time of a sustain data pulse applied in the sustain period, based on the average luminance transmitted from the average luminance detecting unit 230.

A known driver integrated circuit is used for the sustain driver 250. The sustain driver 250 is connected to the Sus electrodes 13 in the panel device 100, and applies an initialize pulse and a sustain pulse to the Sus electrodes 13, respectively, during an initialize period and the sustain period in each subfield, in order to perform an initialize discharge, the sustain discharge, and a removal discharge in a stable manner in all of the discharge cells.

The scan driver 260 is also a known driver integrated circuit. The scan driver 260 is connected to the Scn electrodes 14 in the panel device 100, and applies the initialize pulse, an address pulse, and the sustain pulse to the Scn electrodes 14, respectively, during the initialize period, an address (write) period, and the sustain period in each subfield, in order to perform the initialize discharge, an address (write) discharge; and the sustain discharge in a stable manner in all of the discharge cells.

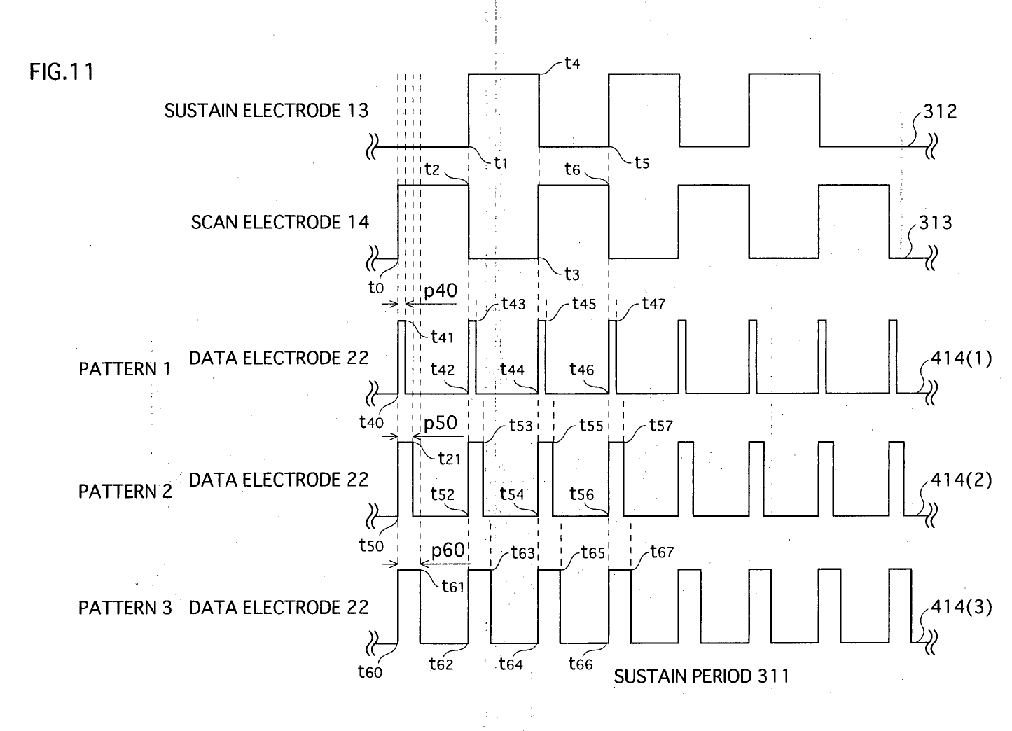

The data driver 270 is also a known driver integrated circuit, such as a driver integrated circuit taught in FIG. 11 of Japanese Laid-Open Patent Application No. 2002-287691. The data driver 270 is connected to the Dat electrodes 22 in the panel device 100. In order to perform the address discharge and sustain discharge in a stable manner in all of the discharge cells, the data driver 270 applies the address pulse to selected Dat electrodes 22 during the address period in each subfield, and applies a sustain data pulse to all of the Dat electrodes 22 during the sustain period in each subfield.

2. Method of Driving PDP Apparatus

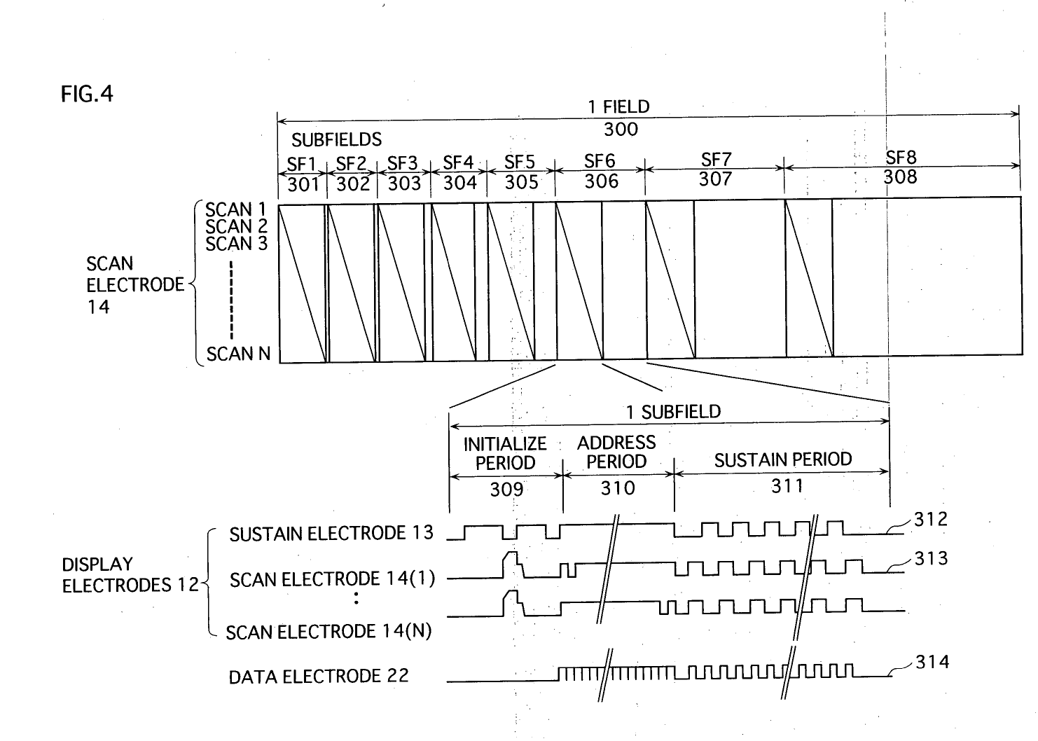

The following describes a method of driving the PDP apparatus according to the present embodiment with reference to FIG. 4. FIG. 4 illustrates the method of driving the PDP apparatus using the field time-sharing grayscale display method.

As shown in FIG. 4, in driving the PDP apparatus according to the present embodiment, one field is divided into eight subfields 301-308, and the number of the sustain pulses is set so that a relative ratio of luminance between subfields is 1:2:4:8:16:32:128. It is possible to realize a 256 grayscale display by a combination of on and off of eight subfields 301-308 controlled according to the data of a display luminance. Note that, although the present embodiment takes an example of the driving method for the 256 grayscale display, the present invention is not restricted to this example.

The subfields 301-308 each include an initialize period 309, an address period 310, and a sustain period 311. The initialize period 309 and address period 310 have a predetermined length of time in all subfields, and a length of the sustain period 311 is set based on the relative ratio of luminance. When the panel device 100 is driven, for example, the initialize discharge is first generated in all of the discharge cells B during the initialize period 309, and the discharge cells are initialized in order to eliminate an effect of a discharge in a preceding subfield and to absorb variations in discharge characteristics.

Next, in the address period 310, the Scn electrodes 14 are scanned by line based on the subfield data, and a small discharge (address discharge) is generated between the Scn electrodes 14 and Dat electrodes 22, in the discharge cells B to be turned on. In the discharge cells B where the small address discharge is generated between the Scn electrodes 14 and Dat electrodes 22, a wall charge is accumulated on a surface of the protection layer 16 of the front panel 1.

Then, the sustain pulses 312 and 313 that are in a rectangular shape are applied respectively to the Sus electrodes 13 and Scn electrodes 14 in the sustain period 311. The sustain pulses 312 and 313 are at a predetermined voltage and in a predetermined cycle (e.g. one cycle is 5 μsec., in which high-level and low-level are each 2.5 μsec.). The cycle of the sustain pulse 312 applied to the Sus electrodes 13 is the same but with half cycle interval to the cycle of the sustain pulse 313 applied to the Scn electrodes 14. The sustain pulses 312 and 313 are applied to all the discharge cells B in the panel device 100.

Further, as shown in FIG. 4, a rectangular pulse (hereinafter referred to as a sustain data pulse) 314 is applied to the data electrodes 22 during the sustain period 311 when driving the PDP apparatus according to the present embodiment.

The sustain data pulse 314 has apredetermined waveform (e.g. a pulse width of 0.3 μsec., and a cycle of 2.5 μsec.) and a predetermined amplitude. A rise start time of the sustain data pulse 314 when the pulse starts to rise varies according to the screen image to be displayed. The sustain data pulse 314 starts to rise after the rise start time of sustain pulses 312 and 313.

The sustain pulses 312 and 313, and the sustain data pulse 314 generate a potential difference between the Sus electrodes 13 and Scn electrodes 14. The sustain discharge is generated when a total sum of the potential difference and a potential difference generated by the wall charge formed by the address discharge exceeds a discharge start voltage Vf.

Ultraviolet light generated during the sustain discharge is converted to visible light by exciting the phosphor layers 25 to emit light. By repeating the above operation in the subfields 301-308, the discharge is generated in the selected discharge cells B aligned in an order corresponding to the image data are to emit light, thereby the image is displayed in a display area of the panel device 100.

3. Sustain Data Pulse 314 Applied to Dat Electrodes 22 During Sustain Period 311

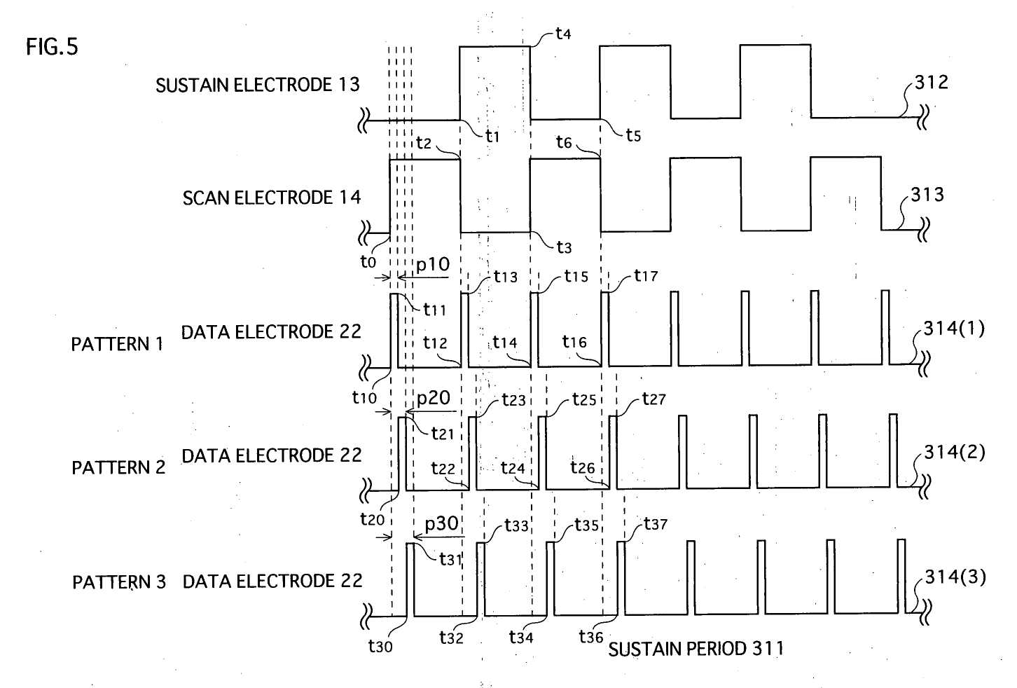

The inventors of the present invention found that it is possible to modulate the luminance when driving the PDP apparatus by changing a fall start time when the sustain data pulse 314 applied to the Dat electrodes 22 starts to fall by changing the rise start time of the sustain data pulse 314 applied to the Dat electrodes 22 when displaying the dark screen image. The following describes the sustain data pulse 314 applied to the Dat electrodes 22 in the sustain period 311. FIG. 5 illustrates waveform patterns each of which has a different fall start time of the sustain data pulse 314. Three patterns are shown, as examples, in the drawing.

As shown in the drawing, the pulse width of the sustain data pulse 314 during the sustain period 311 is constant in all of the patterns 1, 2, and 3.

3-1. Sustain Data Pulse 314(1) in Pattern 1

In Pattern 1, rise start times t10 and t14 of the sustain data pulse 314(1) are set in sync with rise start times t0 and t3 of the sustain pulse 313 and fall start time t4 of the sustain pulse 31. Fall start times t11 and t15 of the sustain data pulse 314(1) are set at times when a time period p10 has passed respectively after the times t0, t3, and t4 of the sustain pulses 312 and 313.

Further, rise start times t12 and t16 of the sustain data pulse 314(1) are set in sync with rise start times t1 and t5 of the sustain pulse 312 and fall start times t2 and t6 of the sustain pulse 313. Fall start times t13 and t17 of the sustain data pulse 314(1) are also set at times when the time period p10 has passed respectively after the times t1, t2, t5, and t6 of the sustain pulses 312 and 313.

3-2. Sustain Data Pulse 314(2) in Pattern 2

The sustain data pulse 314(2) in Pattern 2 has the same pulse width as in Pattern 1. Fall start times t21, t23, t25, and t27 of the sustain data pulse 314(2) are set at times when a time period p20 has passed respectively based on the rise start times t0, t1, t3, and t5 as well as the fall start times t2, t4, and t6 of the sustain pulses 312 and 313. Specifically, pulses in the sustain data pulse 314(2) in Pattern 2 are set to have the rise start times t20, t22, t24, and t26 and fall start times t21, t23, t25, and t27, respectively.

Because the sustain data pulse 314(2) in Pattern 2 has the same pulse width as in Pattern 1, rise start times t20, t22, t24, and t26 of the sustain data pulse 314(2) are set at times when a time period (p20-p10) has passed respectively based on the rise start times t0, t1, t3, and t5 and fall start times t2, t4, and t6 of the sustain pulses 312 and 313.

3-3. Sustain Data Pulse 314(3) in Pattern 3

The sustain data pulse 314(3) in Pattern 3, fall start time t31, t33, t35, and t37 of rectangular pulses are set at times when a time period p30 has passed respectively based on the rise start time t0, t1, t3, and t5 and fall start time t2, t4, and t6 of the sustain pulses 312 and 313. A pulse width of the rectangular pulses in the sustain data pulse 314(3) is the same as the pulse width in the sustain data pulses 314(1) and 314(2).

Accordingly, the sustain data pulse 314(3) in Pattern 3, the rise start times t30, t32, t34, and t36 of the sustain data pulse 314(3) are set at times when a time period (p30-p20) has passed respectively based on the rise start times t0, t1, t3, and t5 and fall start times t2, t4, t6 of the sustain pulses 312 and 313.

Note that the rise start time of each pulse is a time when the voltage of the pulse starts to rise, and the fall start time of each pulse is a time when the voltage of the pulse starts to fall.

4. Relation between Fall Start Time of Sustain Data Pulse 314 and Standardized Luminance

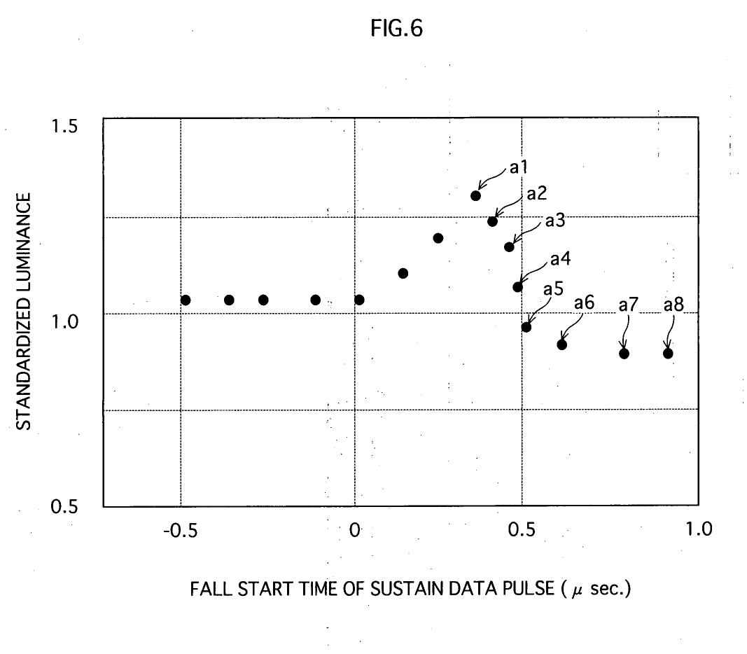

The following describes a relation between the fall start time of the sustain data pulse 314 and standardized luminance of the PDP apparatus with reference to FIG. 6. FIG. 6 is a chart plotting the standardized luminance of the PDP apparatus to the fall start time of the sustain data pulse. The standardized luminance is a luminance ratio when the luminance is “1” if the sustain data pulse is not applied. Note that the fall start time of the sustain data pulse 314 in FIG. 6 is represented by a lapse based on the rise start time and fall start time in pulses 312 and 313, and corresponds to the time period p10, p20, and p30 in FIG. 5.

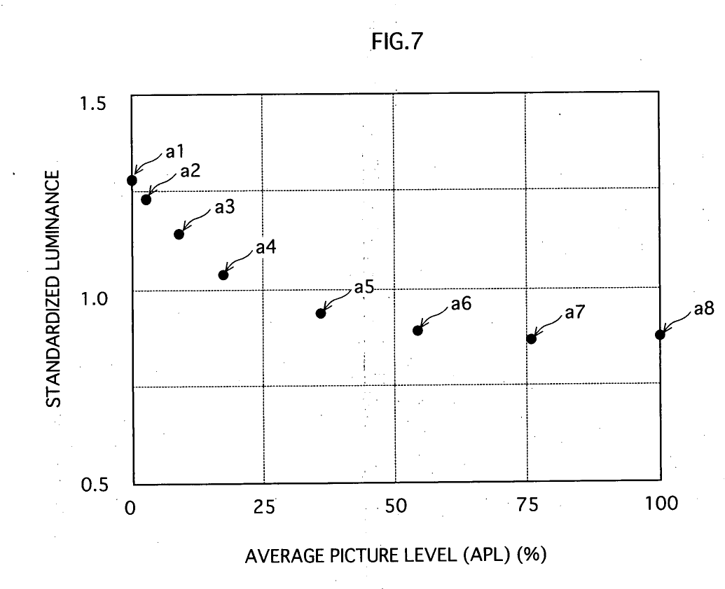

As shown in FIG. 6, although the fall start time of the sustain data pulse 314 is not in a simple proportion to the standardized luminance, the display luminance can be modulated continuously as the fall start time of the sustain data pulse 314 varies. Accordingly, by changing the fall start time of the sustain data pulse 314, it is possible to control to modulate the luminance of the display screen at continuously in detail. An example of a method of modulating the luminance of the display screen continuously by using points a1-a8 in FIG. 6 is described in the following with reference to FIG. 7. FIG. 7 shows the example in which, based on the relation between the fall start time of the sustain data pulse 314 shown in FIG. 6 and the standardized luminance, the points a1-a8 is applied according to average picture level (APL).

As shown in FIG. 6, the standardized luminance at the points a1-a4 exceeds 1.0. Therefore, the points a1-a4 are used as times for a case where APL is under 25%, as shown in FIG. 7. Similarly, the points a1-a4 are used as times for a case where APL is over 25%. As described above, by controlling the fall start time of the sustain data pulse 314 so that the standardized luminance varies according to APL, it becomes possible to display the dark screen image vividly with high contrast ratio even if APL of the screen image is under 25%. Further, the production cost of the apparatus does not increase too much in comparison with a case in which the screen image is displayed virtually in grayscale using the error diffusion method, because it is not required to use an expensive circuit as the drive device 200.

5. Mechanism of Changing Standardized Luminance According to Fall Start Time of Sustain Data Pulse 314

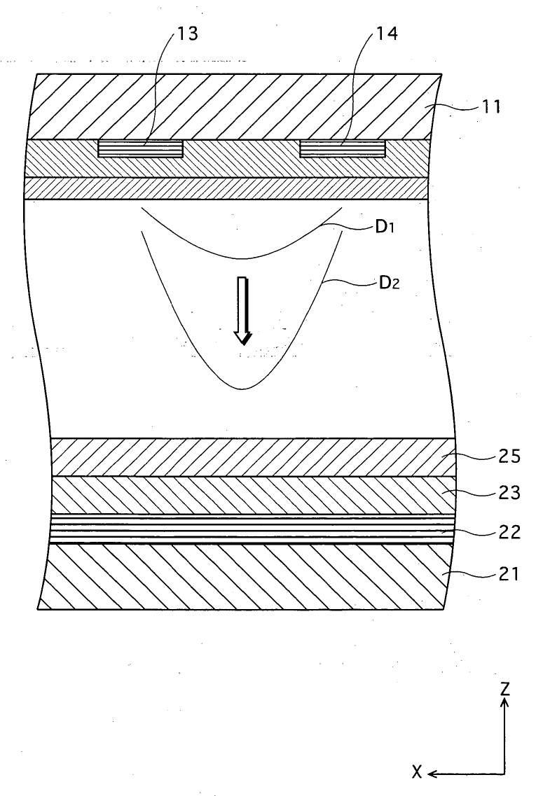

The following describes, with reference to FIG. 8, a mechanism of how the standardized luminance changes according to the fall start time of the sustain data pulse 314 as described above when driving the PDP apparatus according to the present embodiment. FIG. 8 is a schematic diagram illustrating discharge paths of the sustain discharge generated in a discharge space A.

As shown in FIG. 8, when the sustain, data pulse 314 is not applied, or when the fall start time of the sustain data pulse 314 is set so that the standardized luminance does not increase even if the sustain data pulse 314 is applied, a discharge path D1 of the sustain becomes a short arc that connects the Sus electrodes 13 and Scn electrodes 14.

On the other hand, the inventors of the present invention found that a discharge path D2 of the sustain discharge becomes a curved line extending toward the phosphor layers 25 and longer than the discharge path D1. By making the discharge path longer, an amount of ultraviolet light generated increases, and an area where the ultraviolet light is generated becomes closer to the phosphor layers 25. Accordingly, a utilization ratio of the ultraviolet light improves at the phosphor layers 25. It is considered that the improvement of the utilization ratio of the ultraviolet light makes it possible to change the standardized luminance in the PDP apparatus according to the present embodiment.

Therefore, the peak luminance of the displayed screen image can be improved by setting the fall start time of the sustain data pulse 314 so that the standardized luminance becomes high when displaying the dark screen image (See FIG. 7), and controlling the rise start time of the sustain data pulse 314 when displaying a screen image that is not dark. By this, it is possible to display the dark screen image vividly with high contrast without using the error diffusion method. On the other hand, when displaying the screen image whose average luminances is high and does not need to be displayed with an especially high contrast, e.g. bright screen images, are controlled so that the sustain data pulse is not applied, or so that the average luminance does not change even if the sustain data pulse is applied.

6. Method of Controlling Fall Start Time of Sustain Data Pulse 314

The following describes how the time signal of the sustain data pulse 314 that the display control unit 240 transmits to the data driver 270 is controlled.

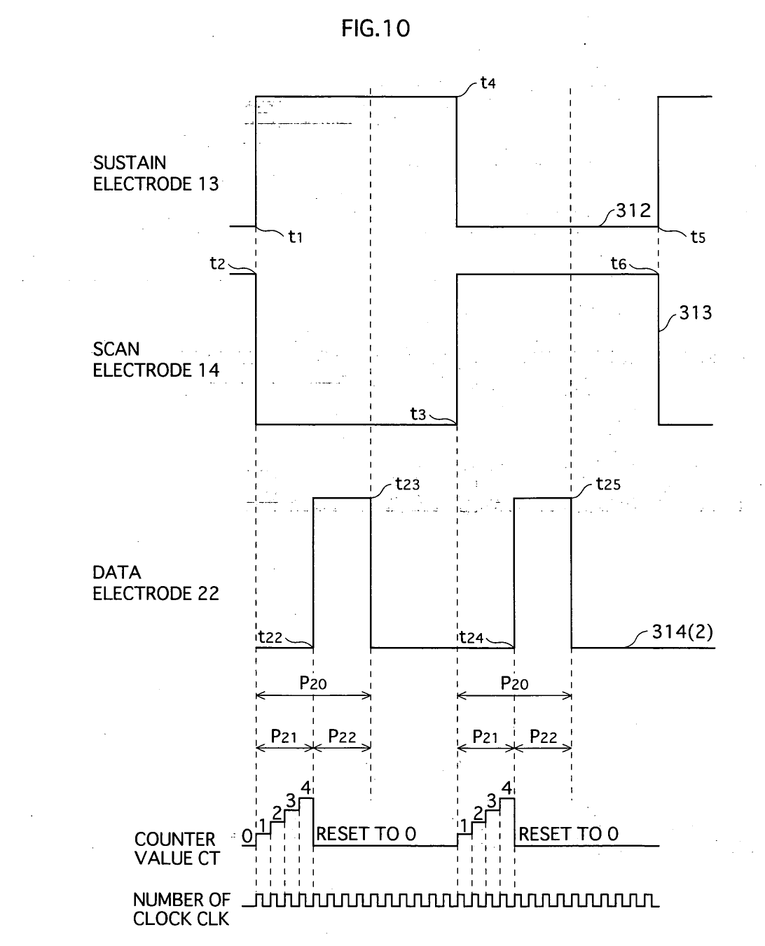

The best sustain data pulse process unit 241 in the display control unit 240 of the PDP apparatus according to the present embodiment stores tables (not shown in the drawings) of the relation between the average luminance in FIG. 6 and the sustain data pulse 314, and of the correspondence between the APL in FIG. 7 and the best fall start time of the sustain data pulse. Because the sustain data pulse 314 is controlled so as to have a constant pulse width, the best fall start time is controlled by controlling the rise start time of the sustain data pulse 314. Further, the rise start time is stored after being converted into a number of clock CLK (See FIG. 10) having a narrower pulse width than the sustain data pulse, and shifts the time according to the number of the clock CLK. In addition, the sustain data pulse is not applied when the number of the clock CLK is 0.

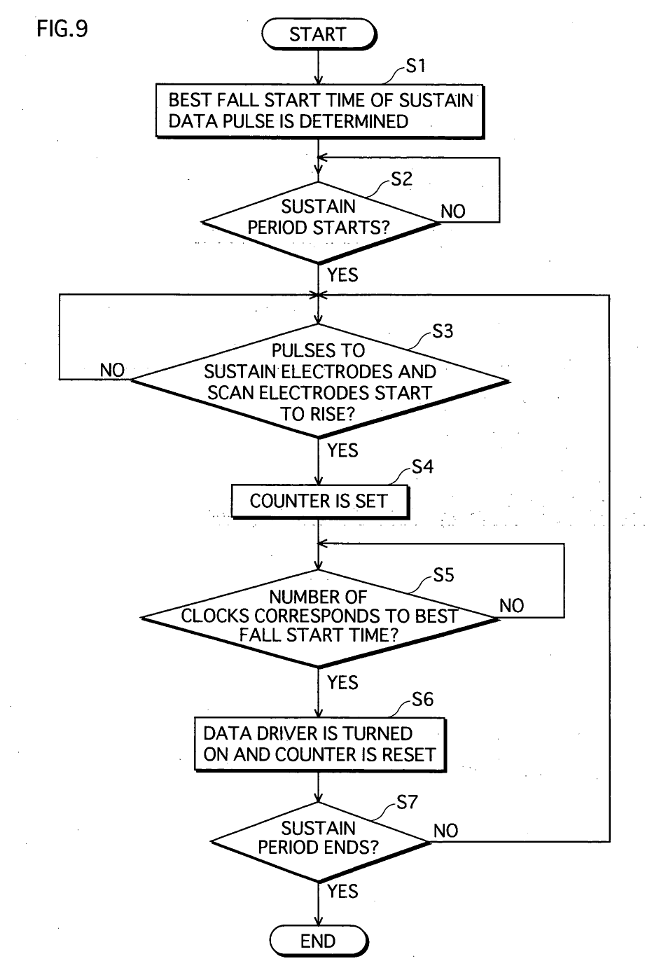

The following explains a specific method of controlling in detail with reference to. FIGS. 9 and 10. FIG. 9 is a flowchart indicating a method of controlling the best sustain data pulse process unit 241, and FIG. 10 shows waveform patterns of voltages applied to the electrodes 13, 14, and 22, respectively, during the sustain period 311. In the FIG. 10, the sustain data pulse 314(2) of Pattern 2 is applied out of three patterns of the sustain data pulse 314 shown in FIG. 5.

As shown in FIG. 9, the best sustain data pulse process unit 241 refers to the tables when the average luminance level is transmitted from the average luminance detecting unit 230 (both depicted in FIG. 1), and determines the best fall start time of the sustain data pulse 314(Step S1). In this flowchart, the rise start time of the sustain data pulse becomes best when the rise start time corresponds to a time period of 4 clocks.

Next, in the sustain period 311 (Step S2:Y), the best sustain data pulse process unit 241 waits till the sustain pulses 312 and 313 are applied respectively to the Sus electrodes 13 and Scn electrodes 14. When application of the sustain pulses 312 and 313 starts, the best sustain data pulse process unit 241 sets a counter to 0 based on the rise start times of the applied pulses 312 and 313 to the Sus electrodes 13 and Scn electrodes 14, respectively (Step S3-S4).

As shown in FIG. 10, the best sustain data pulse process unit 241 first sets the counter to 0 in sync with the rise start time t1 of the sustain pulse 312, when the start of the application of the sustain pulse 312 to the Sus electrodes 13 is detected (Step S3).

The best sustain data pulse process unit 241 includes a clock counter (not depicted in the drawings) for counting the clock CLK.

At a time when the sustain data pulse 314 corresponds to the best fall start time that is stored in the table in advance, i.e. when a counter value CT indicates the number of the clocks that corresponds to the best fall start time as previously set (four clocks, in this case) after the start of the application of the sustain pulse 312 (Step S5:Y), the best sustain data pulse process unit 241 turns on the data driver 270, and has the sustain data pulse 214 start rising. The sustain data pulse 314 is applied to all of the Dat electrodes 22. As shown in FIG. 10, the flow of the operation is as follows. When the time period p21 lapses after the rise start time t1 when the sustain pulse 312 applied to the Sus electrodes 13 has started to rise, the counter value CT becomes “4”, and based on this time t22, the sustain data pulse 314 starts to rise. Then the sustain data pulse 314 starts to fall at the time t23 at an end of the predetermined pulse width (when the time period p22 lapses). As a result, the sustain data pulse 314 starts to fall based on the time when the time period p20 lapses after the rise start time t1 when the sustain pulse 312 applied to the Sus electrodes 13 has started to rise.

The rise start time t3 of the sustain data pulse 314 applied to the Scn electrodes 14 is controlled in the same way as in the above explained flowchart. Further, the rise start times t22 and t24 of the sustain data pulse 314, and the fall start times t23 and t25 that respectively correspond to the rise start times t22 and t24 are defined by the relation explained in FIGS. 6 and 7 stored in the data table in advance as described above.

Moreover, the best sustain data pulse process unit 241 resets the counter to “0” at the same time when the sustain data pulse 314 starts to rise (Step S6). The sustain data pulse 214 is set to start to fall when a predetermined length of time W lapses, and repeats the operations until the sustain period ends (Step S7).

As described above, during the sustain period 311, the sustain data pulse 214 with varying fall start times can be applied according to the average luminance of the screen image data. Therefore, it is possible to display the dark screen image vividly with high contrast ratio with maintaining the correct grayscale, without providing a relatively expensive error diffusion circuit like the conventional PDP apparatuses.

Note that the above control circuit can be such a known circuit as disclosed in Unexamined Japanese Patent Publication Number 2002-536689, although a target to be controlled by the circuit is different.

### SECOND EMBODIMENT

Next, the following describes a method of driving the PDP apparatus according to a second embodiment with reference to FIGS. 11, 12, and 13. An outline of a structure of the PDP apparatus according to the present embodiment is the same as the PDP apparatus according to the first embodiment, and therefore not explained here. In the following, only the method of driving and controlling the best sustain data pulse process unit.

In the first embodiment, the sustain data pulse 314 have the constant pulse width, and the fall start time is controlled by changing the rise start time of the sustain data pulse 314. The inventors of the present invention further found that, when displaying the dark screen image, it is possible to modulate the luminance in the PDP apparatus by controlling the fall start times of the pulses in the sustain data pulse 314, thereby controlling the luminance in the PDP apparatus.

In order to realize this, in the present embodiment, the fall start time of the sustain data pulse 414 is controlled by changing the pulse width while the rise start time of the sustain data pulse 414 is fixed in relation to the sustain pulses 312 and 313.

1. Sustain Data Pulse 414 Applied to Dat Electrodes 22 During Sustain Period 311

Waveforms and timings of the sustain data pulse 414 according to the present embodiment are described with reference to FIG. 11. FIG. 11 illustrates waveform patterns in which the fall start time of the sustain data pulse 314 according to the present embodiment varies. Three patterns are shown, as examples, in the drawing.

As shown in FIG. 11, sustain data pulses 414(1), 414(2), and 414(3) are respectively for Patterns 1, 2, and 3. The rise start times t40, t42, t44, and t46 in Pattern 1, the rise start times t50, t52, t54, and t56 in Pattern 2, and the rise start times t6O, t62, t64, and t66 during the sustain-period 311 are set in sync with the rise start times t0, t1, t3, and t5 of the sustain pulses 312 and 313. The sustain data pulses 414(1), 414(2), and 414(3) have different pulse widths. Specifically, in Patterns 1, 2, and 3, the sustain data pulses 414(1), 414(2), and 414(3) starts to rise in sync with rise start times t0, t1, t3, and t5 of the sustain pulses 312 and 313, and the sustain data pulses 414(1), 414(2), and 414(3) starts to fall at fall start times set according to time periods p40, p5O, and p60 of the patterns.

More specifically, in Pattern 1, the rise start times t40, t42, t44, and t46 of the sustain data pulse 414(1) are set in sync with the rise start times t0, t1, t3, and t5 of the sustain pulses 312 and 313. Fall start times t41, t43, t45, and t47 are set at times when the time period p40 (equal to the pulse width) has passed after the corresponding rise start times.

Similarly, in cases of the sustain data pulses 414(2) of Pattern 2 and 414(3) of Pattern 3, fall start times t51, t53, t55, and t57 of the sustain data pulses 414(2) and t61, t63, t65, and t67 of the sustain data pulses 414(3) are set at times when the time period p50 and p60 (equal to the respective pulse widths): have passed after the corresponding rise start times.

The inventors of the present invention found that the luminance can be modulated sequentially in a similar manner with the PDP apparatus according to the first embodiment, by choosing one of the patterns of the sustain data pulse 414 with the fall start times t41, t43, t45, and t47, t50, t52, t54, and t56, and t60, t62, t64, and t66. By this, with the PDP apparatus, it becomes possible to improve the peak luminance of the dark screen image and displays the dark screen image vividly with high contrast.

2. Method of Controlling Sustain Data Pulse 414

The following describes a method of controlling time signals of the sustain data pulse 414 that are transmitted to the data driver 270 by the display control unit 240.

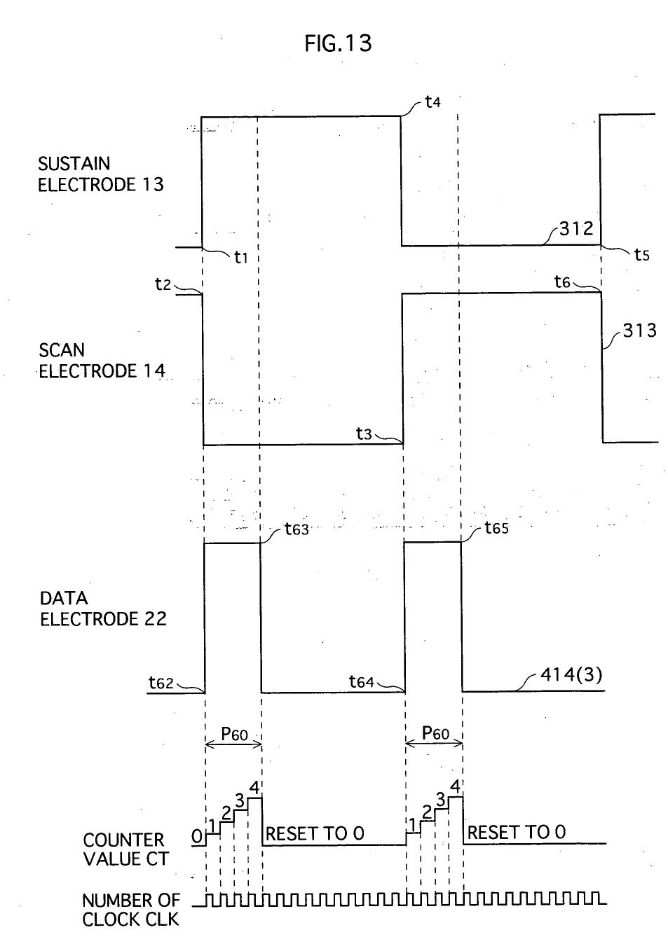

The best sustain data pulse process unit 241 in the display control unit 240 stores, as in the first embodiment, stores the tables (not shown in the drawings) of the relation between the average luminance in FIG. 6 and the sustain data pulse 314, and of the correspondence between the APL in FIG. 7 and the best fall start time of the sustain data pulse. The best fall start time is converted into the number of clock CLK .(See FIG. 13) having a narrower pulse width than the sustain data pulse 414, and the fall start time is set differently according to the number of the clock CLK, as shown by Patterns 1, 2, and 3 in FIG. 11. The number of the clock CLK is set to “0” when the screen image does not need to be corrected for being displayed more vividly with higher contrast, in such a case as a bright screen image having a high average luminance. The sustain data pulse is not applied in this case.

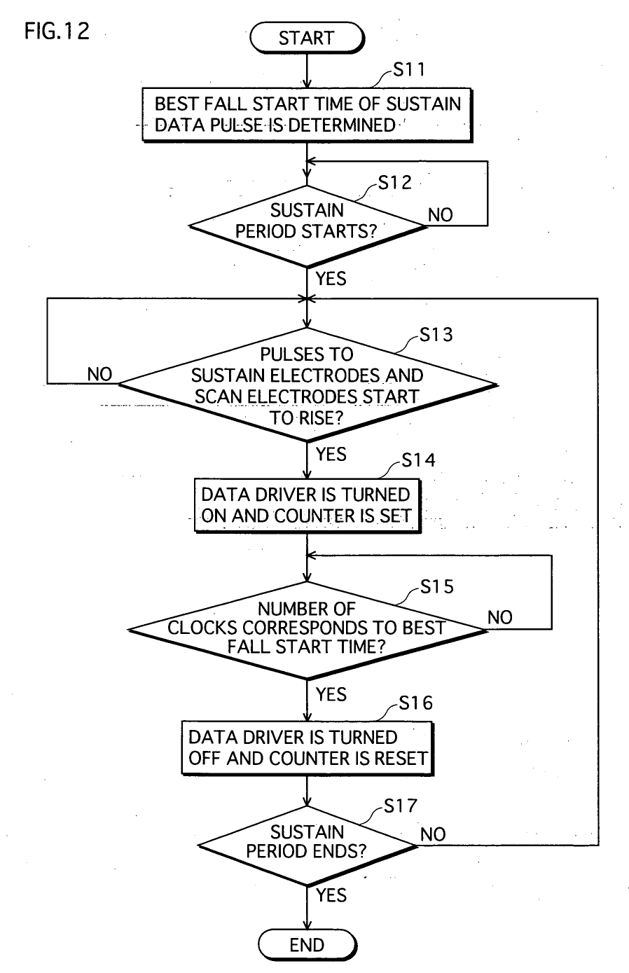

FIG. 12 is a flowchart showing the controlling method performed by the best sustain data pulse process unit 241.

The best sustain data pulse process unit 241 refers to the tables when the average luminance level is transmitted from the average luminance detecting unit 230, and sets the best fall start time of the sustain data pulse 414 (Step S11). In this flowchart, the best fall start time corresponds to a time period of 4 clocks.

Next, in the sustain period (Step S12:Y), the best sustain data pulse process unit 241 waits till the sustain pulses 312 and 313 are applied respectively to the Sus electrodes 13 and Scn electrodes 14 (FIGS. 1 and 2) (Step S13).

FIG. 13 illustrates waveform patterns of voltages applied to the electrodes 13, 14, and 22. Although FIG. 13 shows only the sustain data pulse 414(3) of Pattern 3 out of three patterns, the pulses of Patterns 1 and 2 are set with the same relation as in FIG. 11.

As shown in FIG. 13, by driving the data driver 270 in sync with the rise start times t1 and t5 of the sustain pulses 312 and 313 applied to the Sus electrodes 13 and Scn electrodes 14 (Step S14), the rise start times t62 and t64 of the sustain data pulse 414(3) applied to all of the Dat electrodes 22 are controlled.

The best sustain data pulse process unit 241 includes the clock counter (not depicted in the drawings) for counting the clock CLK, and sets the counter in sync with the rise start times t62 and t64 of the sustain data pulse 414(3) (Step S14).

At a time when the sustain data pulse 414(3) corresponds to the best fall start time, i.e. when a counter value CT indicates the number of the clocks that correspond to the best fall start times t63 and t65 as previously set (four clocks, in this case) after the start of the application of the sustain pulse 312 (Step S15:Y, the best sustain data pulse process unit 241 turns off the data driver 270, resets the counter to “0” at the same time when the sustain data pulse 414 starts to fall (Step S16), and repeats the operations until the sustain period ends (Step S17).

The sustain data pulses 414(1) of Pattern 1 and 414(2) of Pattern 2 shown in FIG. 11 are controlled by setting different counter values so that the fall start times t41, t43, t45, and t47, t50, t52, t54, and t56 are respectively at times that have been set.

As described above, during the sustain period 311, the sustain data pulse 414 with varying best fall start times t41, t43, t45, and t47, t50, t52, t54, and t56, and t60, t62, t64, and t66 can be applied according to the average luminance of the screen image data.

Therefore, with the PDP apparatus according to the present embodiment, like in the first embodiment, it is possible to display the dark screen image vividly with high contrast ratio with maintaining the correct grayscale, without providing the error diffusion circuit.

Note that the above control circuit can be such a known circuit as disclosed in Unexamined Japanese Patent Publication Number 2002-536689, although a target to be controlled by the circuit is different.

### THIRD EMBODIMENT

In the above first and second embodiments, the dark screen image is displayed vividly with high contrast by controlling the fall start times of the sustain data pulses 314 and 414 according to the average luminance. The inventors further found that it is also possible to modulate the luminance in the PDP apparatus by controlling a voltage value of the sustain data pulse, and by this, the dark screen image can be displayed vividly with high contrast.

Thus, in the present embodiment, the voltage is set according to the average luminance, while the fall start times are fixed regardless of the average luminance.

An explanation in the present embodiment mainly focuses on differences between the present embodiment and the first embodiment, i.e. waveforms of the sustain data pulse 514, the method of controlling the best sustain data pulse process unit, and the structure of the-data driver.

1. Sustain Data Pulse 514 Applied to Dat Electrodes 22 During Sustain Period 311

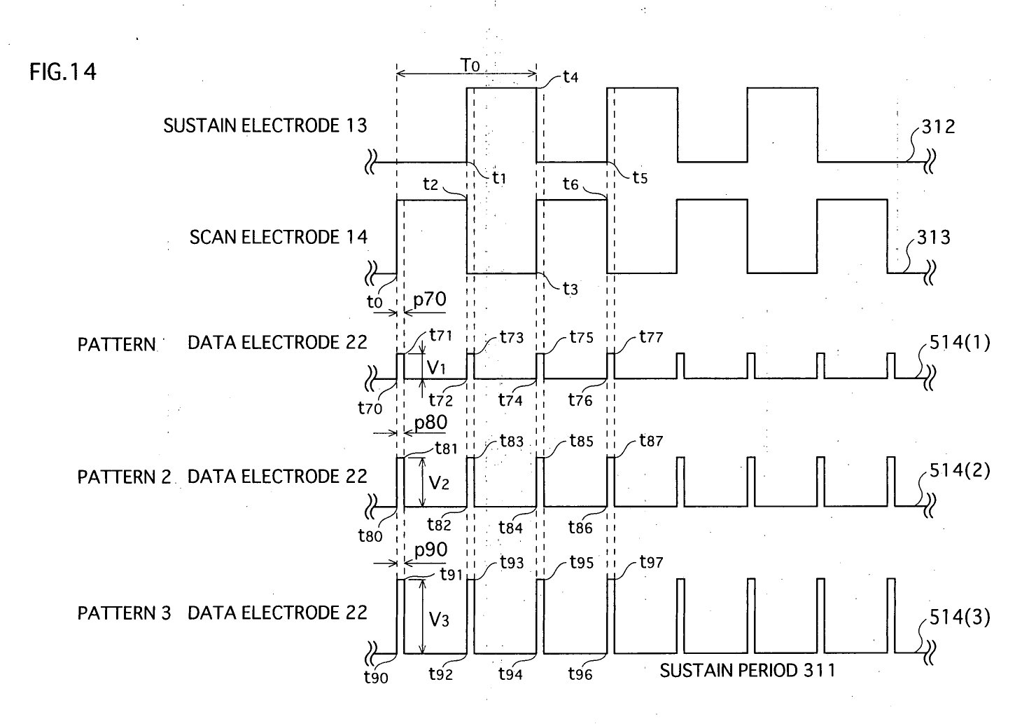

The following describes the sustain data pulse 514 applied to the Dat electrodes 22 during the sustain period 311 in the present embodiment, with reference to FIG. 14. FIG. 14 illustrates waveform patterns when the voltage of the sustain data pulse 514 according to the present embodiment varies. Here, three patterns are shown as examples.

As shown in FIG. 14, in all of patterns 1, 2, and 3, the rise start times t70, . . . , t80, . . . , and t90, . . . of the sustain data pulse 514 during the sustain period 311 are set in synch with the rise start times t0, t1, t3, and t5 of the sustain pulses 312 and 313. Further, the fall start times t71, . . . , t81, . . . , and t91,. . . of all of the patterns 1, 2, and 3 are set to be the same time when a predetermined length of time, which corresponds to the pulse width p70, p80, and p90, passes after the rise start times t0, t1, t3, and t5 of the sustain pulses 312 and 313. Specifically, both the rise start times t70, . . . , t80, . . . , and t90, . . . of the sustain data pulse 514(1)-514(3) of the patterns 1, 2, and 3, and the pulse width p70, p80, and p90 are the same in all of the three patterns.

On the other hand, the sustain data pulse 514(1), 514(2), and 514(3) of the patterns 1, 2, and 3 are respectively controlled to have voltages V1, V2, and V3 (V1<V2<V3) . Here, as the voltage of the sustain data pulse 514 becomes higher, a length of the discharge path of the sustain discharge becomes longer and closer to the phosphor layers 25 as shown by the discharge path D2 in FIG. 8. By this, the intensity of the sustain discharge increases and improves the peak luminance when driving the PDP apparatus for displaying the dark screen image.

Accordingly, also with the PDP apparatus according to the present embodiment, it is possible to increase the luminance of the dark screen image with the correct grayscale without using the error diffusion circuit, by setting the voltages of the sustain data pulse 514 applied during the sustain period 311 according to the average luminance, and thereby improve the peak luminance.

Note that, such a data driver as disclosed in Japanese Laid-Open Patent Application No. 2002-366094 or Japanese Laid-Open Patent Application No. H9-68947 can be utilized as the data driver 270 (FIG. 1) capable of setting the voltages the sustain data pulse 514 according to the average luminance.

2. Method of Controlling Sustain Data Pulse 514

In the present embodiment, the time signal of the sustain data pulse transmitted to the data driver 270 by the display control unit 240 is controlled in the following manner.

The best sustain data pulse process unit 241 in the display control unit 240 contains a table (not depicted in the drawings) of correspondence between the average luminance and the voltages V1, V2, and V3 of the sustain data pulse 514. When the screen image to be displayed does not require any correction in vividness (contrast ratio) such as the bright screen image, the voltage is set to be “0”, and the sustain data pulse 514 is not applied.

Upon reception of the average luminance from the average luminance detecting unit 230, the best sustain data pulse process unit 241 determines the best voltage for the sustain data pulse 514 by referring to the table. The display control unit 240 applies the sustain data pulse 514 (See FIG. 14) i based on the determined voltage, until the end of the sustain period 311.

By this method, the sustain data pulse 514 of the best voltage according to the average luminance of the screen image data can be applied, and it is possible to improve the peak luminance by modulating the luminance of the dark screen image to be higher, and to display the dark screen image vividly with high contrast.

### FOURTH EMBODIMENT

In the above third embodiment, the voltage of the sustain data pulse 514 varies according to the average luminance, and thus the luminance of the PDP apparatus is modulated and the dark screen image is displayed vividly with high contrast. In the present embodiment, however, a cycle of the sustain data pulse 614, in addition to the voltage, varies in order to increase a number of the sustain discharges.

1. Sustain Data Pulse 614 Applied to Dat Electrodes 22 During Sustain Period 311

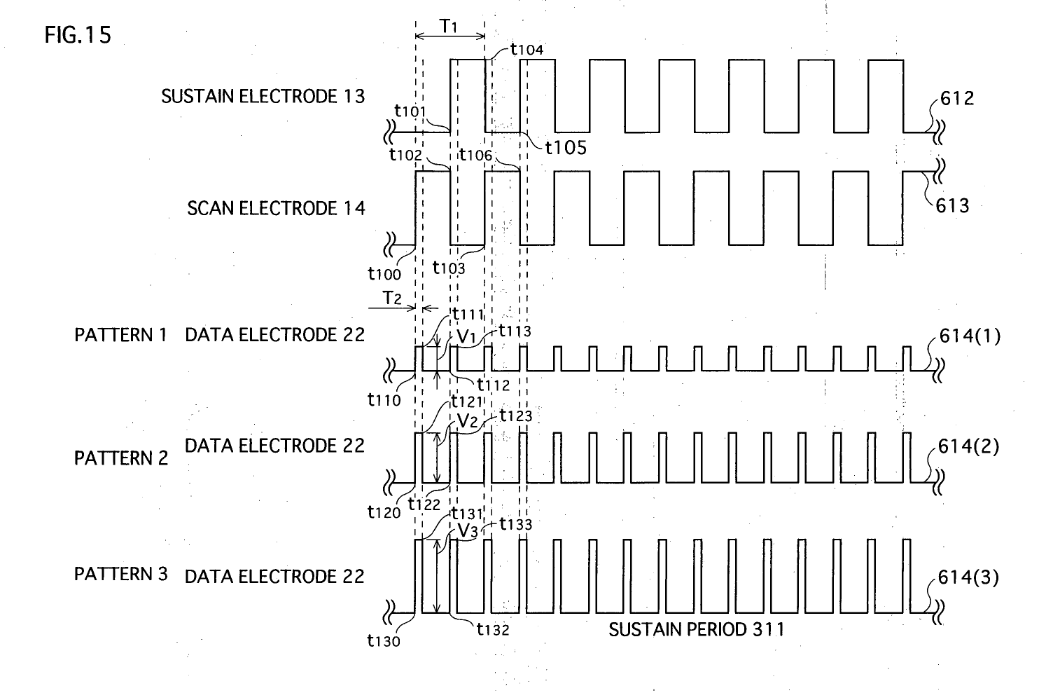

The following describes the sustain data pulse 614 applied to the Dat electrodes 22 during the sustain period 311 with the PDP apparatus according to the present embodiment, with reference to FIG. 15. FIG. 15 illustrates waveform patterns when cycles of sustain pulses 612 and 613 and the sustain data pulse 614 and the voltage of the sustain data pulse 614 according to the present embodiment are altered. Here, three patterns are shown as an example.

As shown in FIG. 15, the pulses 612, 613, and 614(1)-614(3) of the patterns 1, 2, and 3 are the same as the pulses 312, 313, 514(1)-(514(3) in the third embodiment other than that the cycles of the pulses are different.

Specifically, in the third embodiment as shown in FIG. 14, the cycle of the sustain pulses 312 and 313 is set to be T0 (5 μsec., for example) and the cycle of the sustain data pulses 514(1)-514(3) is set to be T0/2 (2.5 μsec., for example). On the other hand, in the present embodiment as shown in FIG. 15, the cycle of the sustain pulses 612 and 613 is set to be T1 (2.5 μsec., for example), and the cycle of the sustain data pulse 614(1)-614(3) is set to T1/2 (1.25 μsec., for example) . Further, the pulse width of the sustain data pulse 614(1)-614-(3) is set to be 0.3 μsec., for example.

With the PDP apparatus according to the present embodiment, it is considered that, when displaying the dark screen image, employing the above driving method increases the voltage of the sustain data pulse 614 as in Pattern 3, and the length of the discharge path as the path D2, as shown in FIG. 8, and makes the discharge path closer to the phosphor layers 25. By this, it is possible to increase the intensity of the sustain discharge and to improve the peak luminance when driving the PDP apparatus.

Further, because making the cycles of the sustain pulses 612 and 613 and the sustain data pulse 614 shorter increases the number of the sustain discharges in one field, the luminance can be improved to a large extent in comparison with the PDP apparatus according to the third embodiment. As a result, it is possible to display the dark screen image more vividly with high contrast without the error diffusion circuit, in comparison with the PDP apparatus according to the third embodiment.

On the other hand, when the screen image to be displayed does not require any correction in vividness (high contrast ratio) such as the bright screen image, the sustain data pulse 614 is not applied and the cycles of the ;sustain pulses 612 and 613 are set to be T0, as in the third embodiment.

The following briefly describes a method of controlling the sustain pulses 612 and 613 and sustain data pulses 614(1)-614(3).

The best sustain data pulse process unit 241 in the display control unit 240 contains tables (not depicted in the drawings) of correspondence between the average luminance and the voltages V1, V2, and V3 of the sustain data pulses 614(1)-614(3), and of correspondence between the average luminance and the cycle of the sustain data pulse 614. Upon reception of the average luminance from the average luminance detecting unit 230, the best sustain data pulse process unit 241 determines the best voltage for the sustain data pulse 614 and the cycles of the pulses 612, 613, and 614 by referring to the tables. The display control unit 240 applies the sustain pulses 612 and 613 and sustain data pulse 614 (See FIG. 15), based on the determined voltage and cycles, until the end of the sustain period. When the screen image to be displayed does not require any correction in vividness. (high contrast ratio) such as the bright screen image, the voltage is set to be “0”, the sustain data pulse 514 is not applied, and the cycles of the sutain pulses 612 and 613 are set to be T0.

In order to increase the number of the sustain discharges as explained above, such a method can be employed as disclosed in Unexamined Japanese Patent Publication Number 2002-536689, which is described in the section of the related art.

### FIFTH EMBODIMENT

The following describes a fifth embodiment with reference to the drawings. Major characteristics of the PDP apparatus according to the present embodiment lie in that a layout of the electrodes on the back panel 3, and that the sustain data pulse 715 is applied in a different manner.

1. Structure of Panel Device 101 of PDP Apparatus According to Present Embodiment

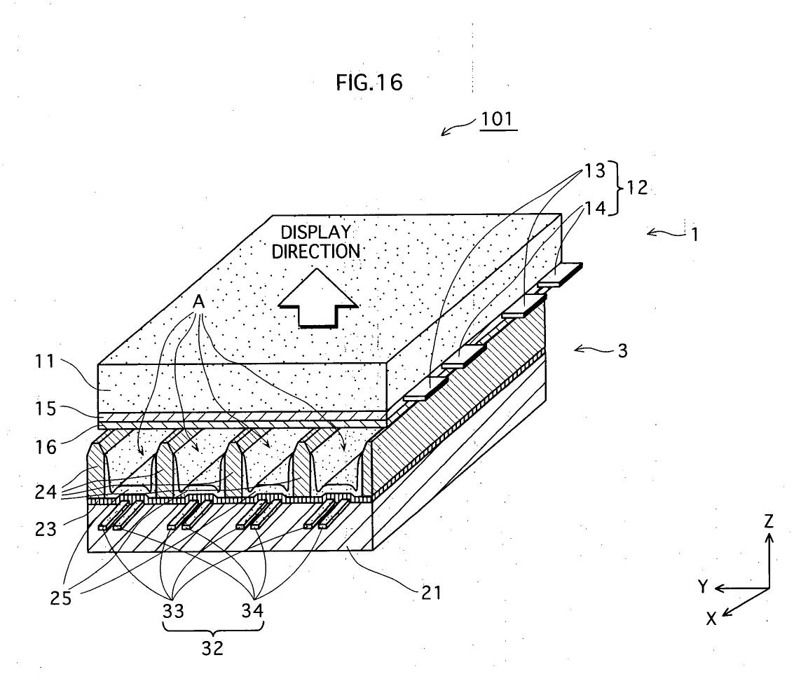

As stated above, an electrode structure of the back panel 3 of the PDP apparatus according to the present embodiment is different from that of the panel device 100 of the PDP apparatus according to the above four embodiments. The following mainly describes, the differences with reference to FIG. 16.

As shown in FIG. 16, the structure of the front panel 1 of a panel device 101 is the same as that of the panel device 100 shown in FIG. 2. Therefore, the front panel 1 is not detailed here.

On a surface of the back panel 3 of the panel device 101 facing the front panel 1 (upper surface in FIG. 16), a plurality of back electrode pairs 12 :are disposed in parallel so as to cross over the display electrode pairs 12. Each back electrode pair 32 includes a Dat electrode 33 and an auxiliary electrode 34. Further, the dielectric layer 23 is formed over the surface of the back substrate 21 so as to cover the back electrode pairs 32, and the barrier ribs 24 and phosphor layers 25 are also disposed over the back substrate 21.

Each discharge cell includes a pair of the Dat electrode 33 and auxiliary electrode 34 therein Materials and thickness of the electrodes are the same as the Dat electrodes 22 and such in FIG. 2.

2. Method of Driving PDP Apparatus According to Present Embodiment

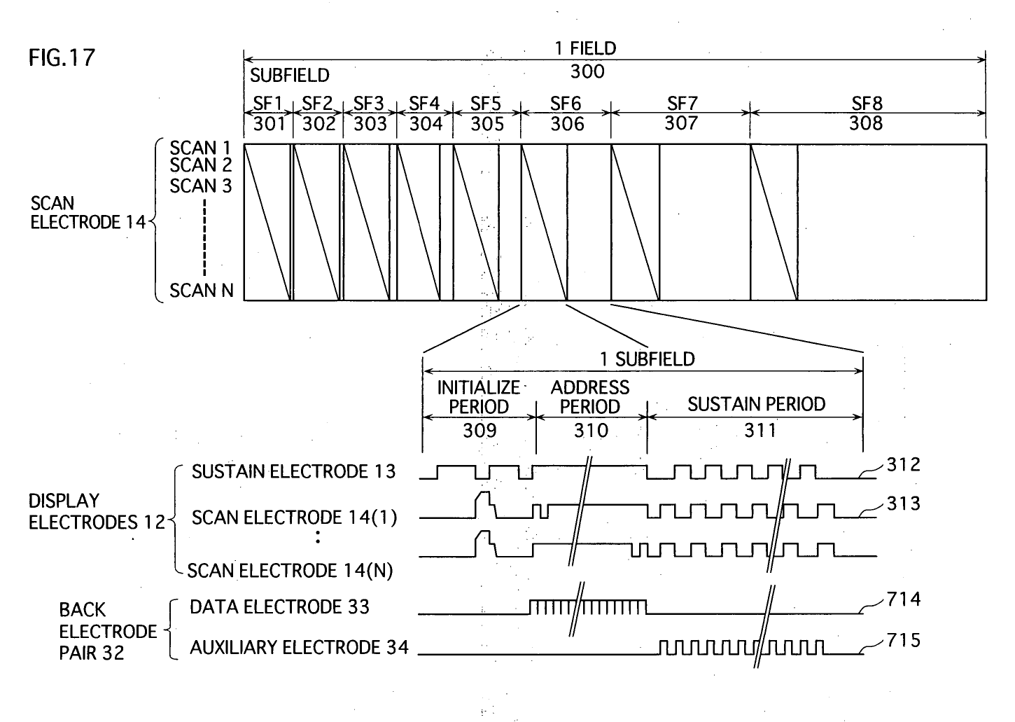

The following describes, with reference to FIG. 17, a method of driving the PDP apparatus according to the present embodiment with the structure as stated above.

As shown in FIG. 17, although pulses applied to the display electrode pairs 12 are the same as in the method described in the first embodiment, electrodes to which a sustain data pulse 715 is applied during the sustain period 311 are different from the case of the first embodiment. Specifically, as shown in FIG. 17, the sustain data pulse is not applied to the Dat electrodes 33 during the sustain period 311 when driving the PDP apparatus. Instead, the sustain data pulse 715 is applied to the auxiliary electrodes 34 during the sustain period 311.

Therefore, with the PDP apparatus according to the present embodiment, it is possible to obtain basically the same effect as the above first to fourth embodiments.

Moreover, as a modified example of the present embodiment, applying the sustain data pulse alternately to the Dat electrodes 33 and auxiliary electrodes 34 during the sustain period 311 when driving the PDP apparatus can make the cycle of the applied pulse for each electrode twice as long in comparison with the case in which the sustain data pulse is not applied alternately, and therefore it is more advantageous in that the timings for pulse application can be set more effectively. Specifically, in a case in which the panel device is required to be driven at high speed, it is possible to suppress a variation in intensity of the sustain discharge caused by applying the sustain data pulse to the Dat electrodes 33 and auxiliary electrodes 34 alternately, instead of applying to only one of the Dat electrodes 33 and auxiliary electrodes 34. Thus, it is more advantageous to obtain the effect.

### SIXTH EMBODIMENT

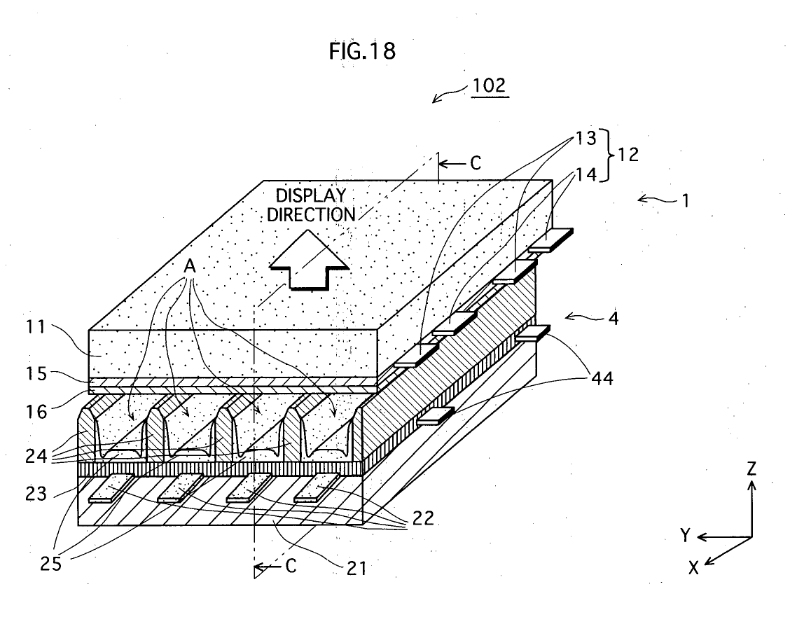

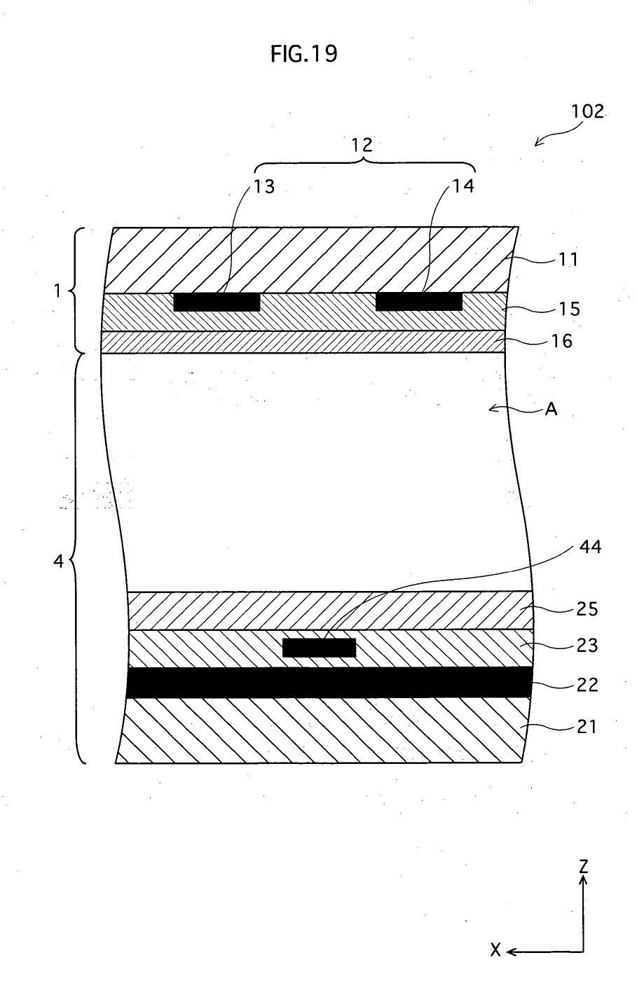

The following describes the PDP apparatus and a method of driving the same according to a sixth embodiment with reference to FIGS. 18 and 19. FIG. 18 is a perspective view (partially sectional) of a main part of a panel device 102 of the PDP apparatus according to the present embodiment FIG. 19 is a sectional view taken at line C-C, illustrating an electrode alignment.

As shown in FIG. 18, major characteristics of the panel device 102 of the PDP apparatus according to the present embodiment lie in the back panel 4. The back panel 4 includes auxiliary electrodes 44 in addition to the Dat electrodes 22, similarly to the case of the panel device 101 according to the fifth embodiment. The auxiliary electrodes 44 are, however, disposed in a Y direction that is substantially orthogonal to the Dat electrodes 22. Specifically, the auxiliary electrodes 44 of the back panel 4 according to the present embodiment are formed substantially in parallel to the display electrode pairs 12.

The Dat electrodes 22 and auxiliary electrodes 44 are not directly in contact with each other, and have the dielectric layer 23 therebetween. How the Dat electrodes 22 and auxiliary electrodes 44 are arranged is shown in FIG. 19.

As shown in FIG. 19, the auxiliary electrodes 44 cross over the Dat electrodes 22 in three dimensional space with a part of the dielectric layer therebetween, and are disposed substantially in parallel to the display electrode pairs 12 (the Sus electrodes 13 and Scn electrodes 14) with the discharge space A therebetween.

The characteristic of the PDP apparatus according to the present embodiment is the PDP apparatus according to the present embodiment includes the panel device 102. The method of driving the PDP apparatus according to the present embodiment can be such a method described in the first to fifth embodiments or in the modification thereof. With the PDP apparatus according to the present embodiment, as the PDP apparatus according to any of the embodiments, it is possible to display the dark screen image vividly with high contrast and high image quality, without making the driving circuit complicated.

Further, as shown in FIG. 18. the panel device 102 according to the present embodiment includes the auxiliary electrodes 44 that cross over the Dat electrodes 22 in three dimensional space, and accordingly, it is possible to make the width (an area of section) of the Dat electrodes 22 wider than that of the Dat electrodes of the panel device 101 of the PDP apparatus according to the fifth embodiment, and thus it is more advantageous considering the electric resistance of the Dat electrodes 22.

Moreover, because the auxiliary electrodes 44 to which the sustain data pulse is applied are in parallel to the display electrode pairs 12 in the present embodiment, an influence of the application of the sustain data pulse to a charge status in the discharge space A can be made more effective. Specifically, while the display electrode pairs 12 and auxiliary electrodes 34 cross over each other in three dimensional space, and therefore an area where both electrodes overlap is smaller in the fifth embodiment, the display electrode pairs 12 and auxiliary electrodes 34 are substantially in parallel and therefore the area where both electrodes overlap is larger in the present embodiment. Thus, it is possible to increase the influence of the application of the sustain data pulse.

### Other Matters

The above six embodiments are described as mare examples to explain characteristics and advantages of the present invention. The present invention may be modified within the scope of the idea of the invention. For example, in the above embodiments, only three patterns of the sustain data pulse are listed, but the patterns may also be two, or more than three. It is also possible, even in such a case, to obtain substantially the same effect as in the above embodiments.

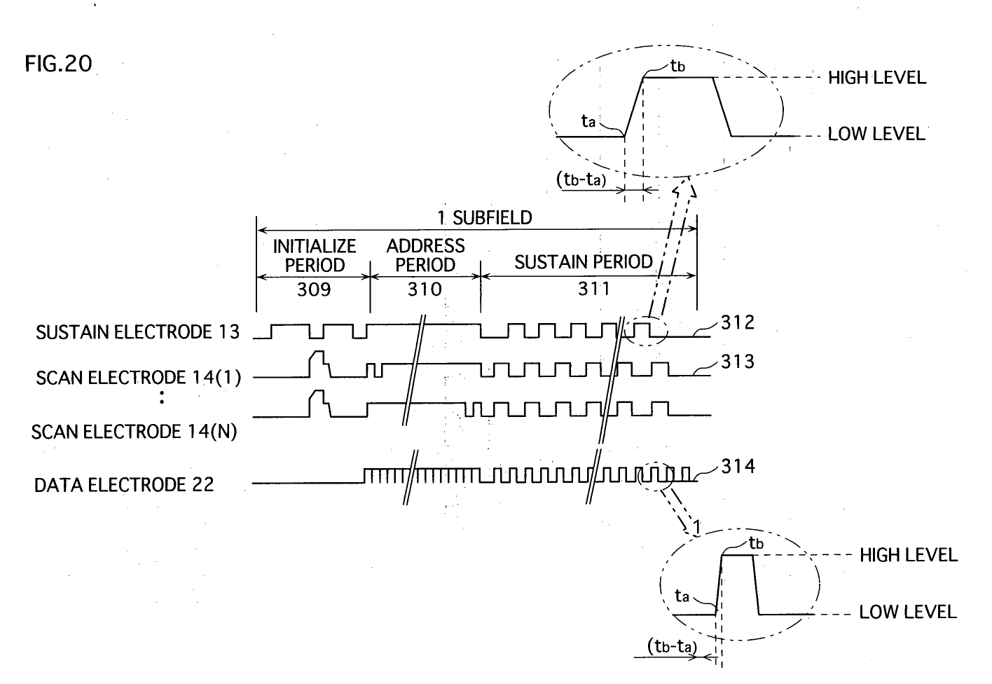

Further, the pulse shape is rectangular in all of the above embodiments, for convenience sake. However, pulses have a ramp part in practice, and even in such a case, it is possible to obtain the effect as explained above within the characteristics of each embodiment. An example of the pulse shape is described with reference to FIG. 20.

As shown in FIG. 20, a slope in a ramp part of the sustain pulse 312 applied to the Sus electrodes 13 is expressed by a formula ((V_{high}−V_{low})/(tb−ta)), when a time ta indicates the time when the voltage starts to shift from low level to high level, and a time tb indicates the time when the voltage reaches the high level. The V_{high} indicates a potential of the sustain pulse 312 at the high level, and the V_{low} indicates a potential of the sustain pulse 312 at the Low level.

As described above, even when the sustain pulses 312 and 313 have a rise ramp, it is possible to obtain the same effect by setting the fall start times of the sustain data pulse 314 based on the rise start times of the sustain pulses 312 and 313, by adding a correction value according to the degree of the slope.

Further, the sustain data pulse 314 itself has a rise ramp and a time difference (td−tc), when a time tc indicates the time when the pulse starts to rise, and a time td indicates the time when the pulse finishes rising. However, tc is used as the rise start time of the sustain data pulse, and the degree of the slope does not have any significant influence.

The most significant characteristic of the present invention is that the sustain data pulse whose fall start times are set according to the average luminance is applied to the Dat electrodes and auxiliary electrodes. Controlling of the rise ramp in the sustain data pulse is not an essential part of the present invention.

Moreover, although not depicted in the above embodiments, in the case in which the auxiliary electrodes in addition to the Dat electrodes are disposed on the back panel, an area where the auxiliary electrodes are disposed may be separated from the discharge space A which is surrounded by the phosphor layers 25, so that only a part of the area contacts the discharge space. In this case, it is possible to dispose a so called black matrix over the area where the auxiliary electrodes are disposed on a side facing the front panel. By such a structure, even when a case in which an auxiliary discharge is caused during the sustain period 311 by applying the sustain data pulse to the auxiliary electrodes, light emitted by the auxiliary discharge is not emitted from the front panel 1, and thus, the present invention demonstrates a superior quality in terms of the image quality.

### INDUSTRIAL APPLICABILITY

The present invention is applicable to display devices that require high definition and high quality display, such as television and computer displays.

1. A plasma display panel apparatus comprising:
a panel device being a sealed container that includes two parts facing each other across a discharge space in which a discharge gas is enclosed, one of the parts having a plurality of electrode pairs of a first electrode and a second electrode, the other of the parts having a plurality of third electrodes, and discharge cells being formed where the third electrodes cross over the electrode pairs; and
a drive device driving the panel device to perform image display, based on inputted image data, by sequentially generating an address discharge between the first and third electrodes and a sustain discharge between the first and second electrodes in selected discharge cells, wherein
the drive device includes:
a detecting unit operable to detect, from the inputted image data, an average luminance of a screen image to be displayed; and
a control unit operable to, when generating the sustain discharge, apply a modulation voltage that is set according to the average luminance to the third electrodes, thereby modulating a luminance of the screen image when displayed.

2. A plasma display panel apparatus according to claim 1, wherein
the modulation voltage has a pulse waveform, and
the control unit sets a fall start time of the pulse waveform according to the average luminance.

3. A plasma display panel apparatus according to claim 2, wherein
the pulse waveform has a predetermined pulse width, and
the control unit sets a rise start time of the pulse waveform according to the average luminance, and sets the fall start time based on the rise start time.

4. A plasma display panel apparatus according to claim 2, wherein
the control unit sets a pulse width of the pulse waveform according to a voltage waveform applied between the first and second electrodes when generating the sustain discharge, and sets the fall start time based on the pulse width.

5. A plasma display panel apparatus according to claim 1, wherein
the modulation voltage has a pulse waveform, and
the control unit sets an amplitude of the pulse waveform according to the average luminance.

6. A plasma display panel apparatus according to claim 5, wherein
the control unit sets a cycle of the pulse waveform according to the average luminance.

7. A plasma display panel apparatus according to claim 6, wherein
the control unit sets a cycle of a voltage waveform applied between the first and second electrodes when generating the sustain discharge, according to the average luminance.

8. A plasma display panel apparatus according to claim 1, wherein
the two parts included in the sealed container are a front panel and a back panel that are sealed around periphery thereof, and
the first electrodes and second electrodes are scan electrodes and sustain electrodes, respectively, and disposed on the front panel.

9. A plasma display panel apparatus according to claim 8, wherein
the third electrodes are data electrodes disposed on the back panel so as to cross over the scan and sustain electrodes.

10. A plasma display panel apparatus according to claim 9, wherein
a plurality of auxiliary electrodes are disposed on the back panel, so as to either be parallel to or cross over the data electrodes in three dimensional space, and
the drive device applies an auxiliary voltage to the auxiliary electrodes during the sustain discharge at half cycle interval to the modulation voltage.

11. A method of driving a plasma display panel apparatus in which a panel device is driven to perform image display, based on inputted image data, by sequentially generating an address discharge and a sustain discharge, the panel device being a sealed container including two parts facing each other across a discharge space in which a discharge gas is enclosed, discharge cells being formed where a plurality of third electrodes disposed on one part cross over a plurality of electrode pairs disposed on the other part, each of the electrode pairs including a first electrode and a second electrode, the address discharge being performed between the first and third electrodes in selected discharge cells, and the sustain discharge being performed between the first and second electrodes in the selected discharge cells, the method comprising steps of:
detecting, from the inputted image data, an average luminance of a screen image to be displayed; and
controlling to, when generating the sustain discharge, apply a modulation voltage that is set according to the average luminance to the third electrodes, thereby modulating a luminance of the screen image when displayed.

12. A method of driving a plasma display panel apparatus according to claim 11, wherein
the modulation voltage has a pulse waveform, and
in the controlling, a fall start time of the pulse waveform is set according to the average luminance

13. A method of driving a plasma display panel apparatus according to claim 12, wherein
in the controlling, a rise start time of the pulse waveform is set in sync with a rise start time of a voltage waveform applied between the first and second electrodes, and the fall start time is set based on a pulse width set according to the average luminance.

14. A method of driving a plasma display panel apparatus according to claim 12, wherein
the pulse waveform has a predetermined pulse width, and
in the controlling, the fall start time is set based on a rise start time set according to the average luminance.

15. A method of driving a plasma display panel apparatus according to claim 11, wherein
the modulation voltage has a pulse waveform, and
in the controlling, a voltage of the pulse waveform is set according to the average luminance.

16. A method of driving a plasma display panel apparatus according to claim 15, wherein
in the controlling, a cycle of the pulse waveform is set according to the average luminance.

17. A method of driving a plasma display panel apparatus according to claim 16, wherein
a cycle of a voltage waveform applied between the first and second electrodes when generating the sustain discharge is set according to the average luminance.
